(19) United States
(12) Patent Application Publication
(10) Pub. No.: US 2011/0193881 A1
(43) Pub. Date: Aug. 11, 2011

(54) REGULATION OF NAVIGATION SPEED AMONG DISPLAYED ITEMS AND TILT ANGLE THEREOF RESPONSIVE TO USER APPLIED PRESSURE

(75) Inventor: Tobias Rydenhag, Malmo (SE)

(73) Assignee: Sony Ericsson Mobile Communications AB

(21) Appl. No.: 12/724,796

(22) Filed: Mar. 16, 2010

Related U.S. Application Data
(60) Provisional application No. 61/301,898, filed on Feb. 5, 2010.

(51) Int. Cl. G09G 5/00

(52) U.S. Cl. 345/647; 345/684; 345/661; 345/173

(57) ABSTRACT

An electronic device can include a touch sensitive display screen and a controller circuit. The touch sensitive display screen identifies a location where a user is pressing and generates a force signal that indicates how hard the user is pressing. The controller circuit controls a speed at which information items are scrolled across the screen and controls a tilt angle of the displayed information items responsive to the force signal. The controller circuit graphically renders the tilt angle on the screen by tapering width of the displayed information items in a defined direction and regulates the tapered width responsive to the force signal. No tilt angle is rendered when the force signal indicates that the user is not pressing the screen. The scrolling speed and the tilt angle of the displayed information items are increased, to provide a visual indication to the user of the increased scrolling speed, responsive to the force signal indicating that the user is pressing harder against the screen.

### CROSS-REFERENCE TO RELATED APPLICATIONS

This U.S. non-provisional patent application claims priority to U.S. Patent Application No. 61/301,898, filed on Feb. 5, 2010, the entire contents of which are hereby incorporated by reference.

### FIELD OF THE INVENTION

The present invention relates to mobile communication terminals and, more particularly, to methods and apparatus that provide user interfaces for navigating among displayed items.

### BACKGROUND

Smart phones and other electronic devices, such as the iPhone, have been developed that provide users with new and more efficient and/or intuitive ways to navigate lists of displayed items. Compared with previous approaches of manipulating a joystick/buttons to cause upward or downward movement among a list of displayed items, the iPhone's user interface that allows users to use drag and flick gestures on a touch screen to navigate among a list of displayed items has generally received high consumer praise. One disadvantage of this navigation style is what some users referred to as “pawing”, where a user has to repeatedly use flicking gestures to move through long lists to find desired items.

### SUMMARY OF EMBODIMENTS OF THE INVENTION

In some embodiments of the present invention, an electronic device includes a display screen, a force sensor, and a controller circuit. The force sensor generates a force signal that indicates an amount of force being exerted thereon by a user. The controller circuit controls a speed at which information items are scrolled on the display screen responsive to the force signal.

In some further embodiments, the controller circuit controls a speed at which information items are scrolled across the display screen and controls a tilt angle of the displayed information items responsive to the force signal. The controller circuit may be configured to display the information items with no tilt angle when the force signal indicates that no force from the user is sensed by the force sensor.

The controller circuit may be further configured to graphically render the tilt angle of the displayed information items including by tapering width of the displayed information items in a defined direction and by regulating the tapered width of the displayed information items responsive to the force signal.

The display screen may include a touch sensitive display screen that is configured to identify a location thereon where a user is pressing, and the force sensor is configured so that the force signal indicates how hard the user is pressing against the touch sensitive display screen. The controller circuit may be further configured to control the scrolling speed and tilt angle of the information items that are displayed on the touch sensitive display screen responsive to the force signal. The controller circuit may increase the scrolling speed and increase the tilt angle of the displayed information items, to provide a visual indication to the user of the increased scrolling speed, responsive to the force signal indicating that the user is pressing harder against the touch sensitive display screen. The controller circuit may similarly decrease the scrolling speed and decrease the tilt angle of the displayed information items, to provide a visual indication to the user of the decreased scrolling speed, responsive to the force signal indicating that the user is pressing less hard against the touch sensitive display screen.

The controller circuit may scroll the displayed information items in a first direction in response to the user touching within a first region of the touch sensitive display screen and while regulating the scrolling speed in the first direction responsive to the force signal. The controller circuit may also scroll the displayed information items in an opposite second direction in response to the user touching the touch sensitive display screen within a second region, which is spaced apart from the first region, and while regulating the scrolling speed in the second direction responsive to the force signal.

The controller circuit may increase the scrolling speed and decrease the tilt angle of the displayed information items, to provide a visual indication to the user of the increased scrolling speed, responsive to the force signal indicating that the user is pressing harder against the touch sensitive display screen. The controller circuit may also decrease the scrolling speed and increase the tilt angle of the displayed information items, to provide a visual indication to the user of the decreased scrolling speed, responsive to the force signal indicating that the user is pressing less hard against the touch sensitive display screen.

The controller circuit may display a defined object at the location where the user is pressing against the touch sensitive display screen. The controller circuit may decrease the size of the displayed object responsive to the force signal indicating that the user is pressing harder against the touch sensitive display screen, and may increase the size of the displayed object responsive to the force signal indicating that the user is pressing less hard against the touch sensitive display screen.

The controller circuit may display a defined object at the location where the user is pressing against the touch sensitive display screen, and may increase the size of the displayed object responsive to the force signal indicating that the user is pressing harder against the touch sensitive display screen, and decrease the size of the displayed object responsive to the force signal indicating that the user is pressing less hard against the touch sensitive display screen.

The controller circuit may be further configured to scroll an arrangement of pictures across the display screen and to control the scroll speed and the tilt angle of the displayed arrangement of pictures responsive to the force signal. The controller circuit may graphically render the tilt angle of the displayed arrangement of pictures including by tapering width of the displayed arrangement of pictures in a defined direction and by regulating the tapered arrangement width of the displayed arrangement of pictures responsive to the force signal. The controller circuit may control a leaning angle of individual ones of the displayed pictures responsive to the force signal including by graphically rendering the individual pictures with a tapered picture width of the individual pictures in the defined direction and by regulating the tapered individual picture width responsive to the force signal.

The controller circuit may increase both the tilt angle of the arrangement of pictures and the leaning angle of each of the pictures within the arrangement in response to the force signal indicating that the user is exerting a greater force on the force sensor, and may decrease both the tilt angle of the arrange of pictures and the leaning angle of each of the pictures within the arrangement in response to the force signal indicating that the user is exerting less force on the force sensor.

The controller circuit may be configured to scroll through a stacked arrangement of pictures on the display screen by sequentially flipping through the pictures to sequentially reveal a next picture in the arrangement while adding further pictures to a back end of the arrangement, and to control speed at which the pictures are sequentially flipped through responsive to the force signal. The controller may flip through the pictures in the arrangement in a first direction in response to the user touching the display screen within a first region and while regulating the flipping speed in the first direction responsive to the force signal, and may flip through the pictures in the arrangement in an opposite second direction in response to the user touching the touch sensitive display screen within a second region, which is spaced apart from the first region, and while regulating the flipping speed in the second direction responsive to the force signal.

The controller circuit may sequentially flip pictures downward from an upright orientation to a flat orientation to sequential reveal a next picture in the arrangement, and control the flipping speed responsive to the force signal. The controller circuit may cease flipping through the pictures responsive to the force signal indicating that the user is not exerting force against the force sensor.

The controller circuit may render the pictures in the arrangement to be illustrative of a stack of music/video album covers, and may sequentially flip through the stack of music/video album covers to sequential reveal a next music/video album cover in the stack, and to control the flipping speed responsive to the force signal.

In some other embodiments, an electronic device includes a touch sensitive display screen and a controller circuit. The touch sensitive display screen is configured to identify a location where a user is pressing and to generate a force signal that indicates how hard the user is pressing. The controller circuit is configured to control a speed at which information items are scrolled across the screen and to control a tilt angle of the displayed information items responsive to the force signal. The controller circuit graphically renders the tilt angle on the screen by tapering width of the displayed information items in a defined direction and regulates the tapered width responsive to the force signal. The controller circuit renders no tilt angle when the force signal indicates that the user is not pressing the screen. The controller circuit increases the scrolling speed and the tilt angle of the displayed information items, to provide a visual indication to the user of the increased scrolling speed, responsive to the force signal indicating that the user is pressing harder against the screen.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIGS. 1-11 are exemplary photographs of a display of an electronic device that controls tilting of a list of displayed items and controls the rate of scrolling of the displayed items in response to a measure of force exerted by a user on the display in accordance with some embodiments of the present invention;

FIGS. 12-24 are exemplary photographs of a display of an electronic device that controls tilting of displayed items in a list and controls the rate of scrolling of displayed items in response to a measure of force exerted by a user on the display in accordance with some other embodiments of the present invention;

FIGS. 25-35 are exemplary photographs of a display of an electronic device that controls tilting of displayed items and controls the rate of scrolling/flipping-through of the displayed items in response to a measure of force exerted by a user on the display in accordance with some other embodiments of the present invention; and

FIG. 36 is a block diagram of an electronic device that is configured to operate in accordance with at least some embodiments that are described herein.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Exemplary embodiments are described below with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer-usable or computer-readable medium may be, for example but not limited to, an electronic, magnetic, optical, electromagnetic, or semiconductor data storage system, apparatus, or device. More specific examples (a non-exhaustive list) of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

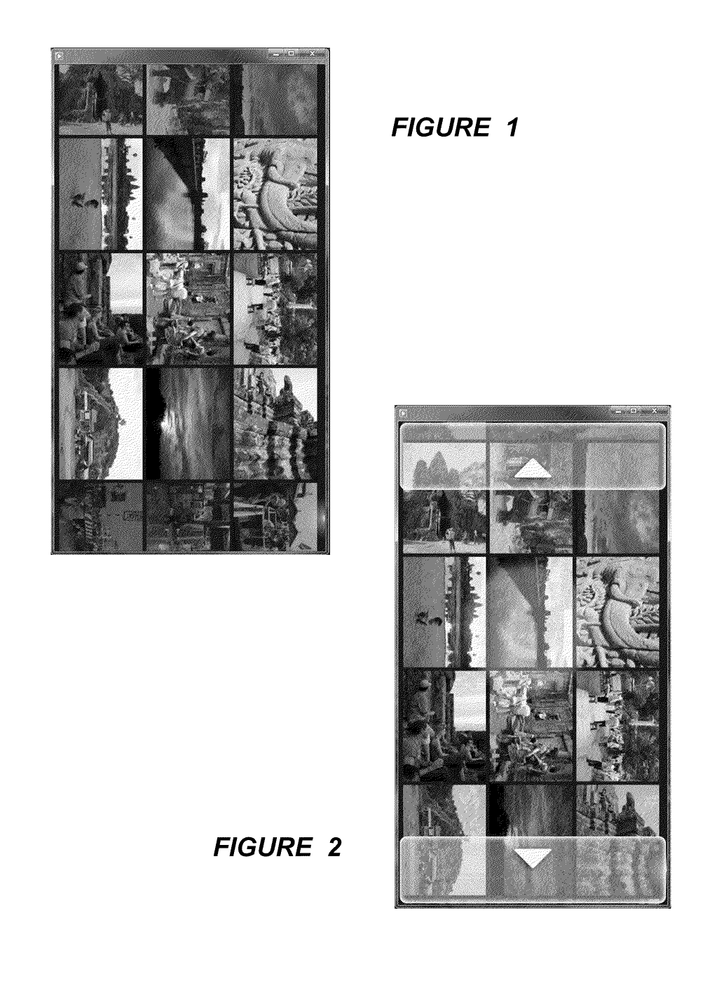

Electronic devices, such as cellular phones and portable music/movie player devices, often have user interfaces that incorporate a touch screen for inputting information and/or making selections. In accordance with some embodiments, electronic devices can include a touch screen that provides both position sensing (e.g., X and Y axis information) along with force sensing (e.g., Z axis information) that identifies how much force a user is pressing against the screen at the sensed position. Various embodiments of the present invention may arise from the present realization that such force sensing capability may be used to enable a user to control the rate at which displayed items are scrolled across a display screen and, moreover, to control tilting of the displayed items to provide virtual three-dimensional visual feedback to the user of the rate at which the items are being scrolled. The user may thereby regulate how hard he/she is pressing the screen to control the rate at which the information are scrolled across the display screen, and which may be carried out without any/substantial movement of the user's finger (e.g., scrolling may be controlled without requiring finger flicking or other type gestures). Moreover, the user may control the direction of the scrolling responsive to where the display screen is being touched. These and other embodiments are illustrated in FIGS. 1-37 and described in further detail below.

For purposes of illustration and explanation only, various embodiments of the present invention are described herein in the context of mobile communication terminals (“wireless terminals” or “terminals”) that are configured to communicate through a cellular communication interface, a wireless local area network (WLAN) interface, and/or and Bluetooth wireless interface. It will be understood, however, that the present invention is not limited to such embodiments and may be embodied generally in any type of electronic device that includes a display screen, such as a touch sensitive display screen (also referred to as a “screen”), and is configured to control scrolling of displayed information responsive to an indication of how much force a user is exerting against the device, such as how hard the user is pressing a finger against screen.

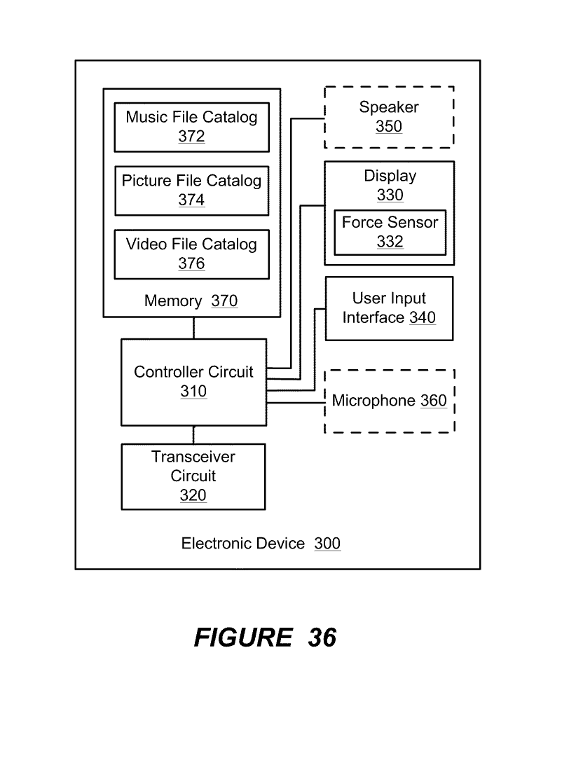

FIGS. 1-35 are exemplary photographs (screen-shots) of a touch sensitive display screen of an electronic device that is operating in accordance with various different embodiments of the invention. An exemplary configuration of an electronic device that may be configured to operate in accordance at least some embodiments is described later with regard to FIG. 36. The electronic device is configured to sense how much force a user is pressing an object (e.g., a finger, stylus, etc.) against the screen, and it may be further configured to determine where the screen is being touched. For purposes of explanation only, the location where a user is pressing the screen is illustrated on the screen by a lightened circle. The diameter of the displayed circle is varied to visually illustrate the amount of force at which the user is pressing the screen. More particularly, less force is visually illustrated by a larger diameter circle and greater force is visually illustrated by a smaller diameter circle, although the electronic device may be configured to oppositely control the diameter of the displayed circle. Although the circle has been illustrated in these figures to visually illustrate how much force a user is exerting and facilitate explanation of how the sensed force controls areas functionality of the electronic device, the invention is not limited to displaying such a circle or other shape and, accordingly, in some embodiments no such circle or other shape is displayed at a location of the user is touching the screen.

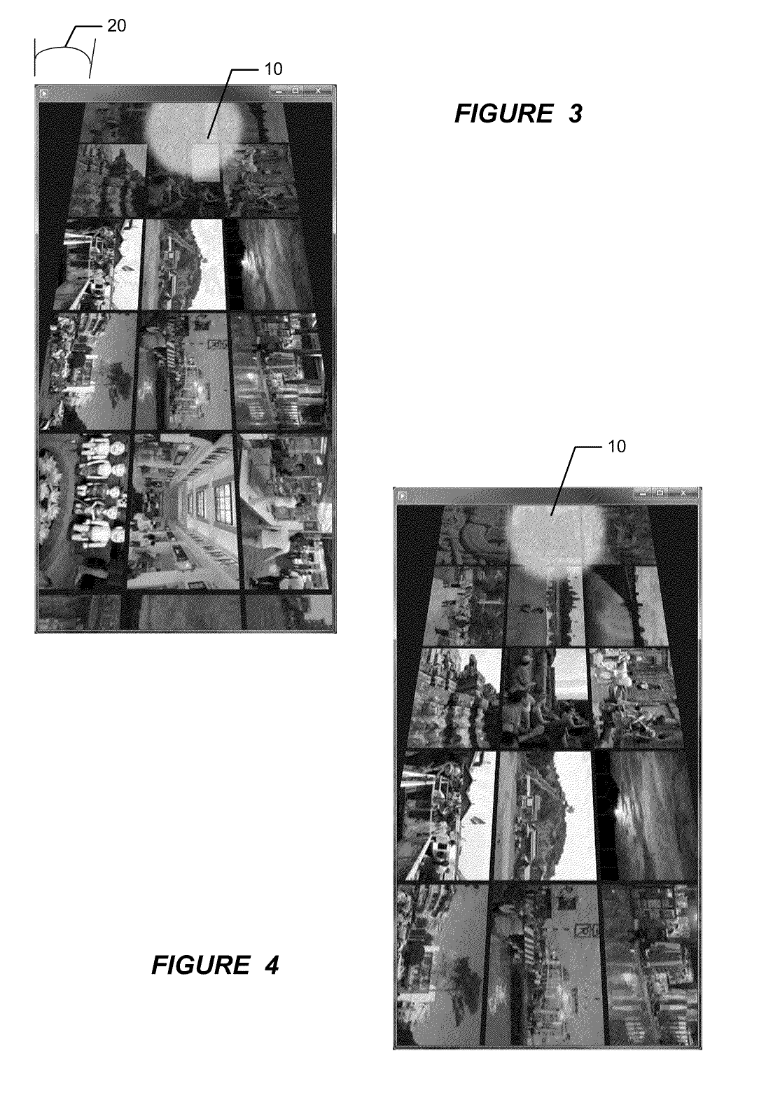

FIGS. 1-11 are exemplary photographs (screen-shots) of a screen of an electronic device that controls tilting of a list of displayed items and controls the rate of scrolling of the displayed items in response to a measure of force exerted by a user on the screen, in accordance with some embodiments of the present invention. FIG. 1 illustrates thumbnail pictures from a catalogue of pictures that reside in a memory within the electronic device. The pictures may, for example, correspond to static digital pictures, freeze frame images from the same or different movies, and/or other graphical items that can be displayed in an ordered arrangement (e.g., array, list, etc.). The electronic device is configured to respond to a user's touch on the screen by activating a scrolling function. Referring to FIG. 2, two user selectable regions (top region of screen and bottom region of screen) are displayed in which a user may control the electronic device to scroll in one direction (e.g., upward) or in the another direction (e.g., downward) through what pictures are displayed from a picture catalog. Referring to FIGS. 3-10, the electronic device further controls tilting of the displayed items and the rate of scrolling of the displayed items in response to how much force the user is exerting at various touch points on the screen.

Referring to FIG. 3, the user initially is pressing lightly on the screen (e.g. above a first threshold force), which is illustrated by the relatively large circle 10, and which causes the displayed picture thumbnails to be collectively tilted at a virtual first angle 20 (e.g. a virtual three-dimensional angle relative to a plan view of the display screen) relative to the display and to be scrolled upward at a first speed. Accordingly, as illustrated, tilting of the displayed picture thumbnails on the display screen can be graphically rendered by tapering width of the collection of displayed picture thumbnails in a defined direction (e.g., from bottom to top of the display). The tapered width of the collection of displayed picture thumbnails can be regulated in response to the amount of force that a user is exerting on the screen. FIG. 4 shows another sequential snapshot, which follows that shown in FIG. 3, as the user continues to lightly press the screen to cause further upward scrolling of the picture thumbnails that are displayed thereon.

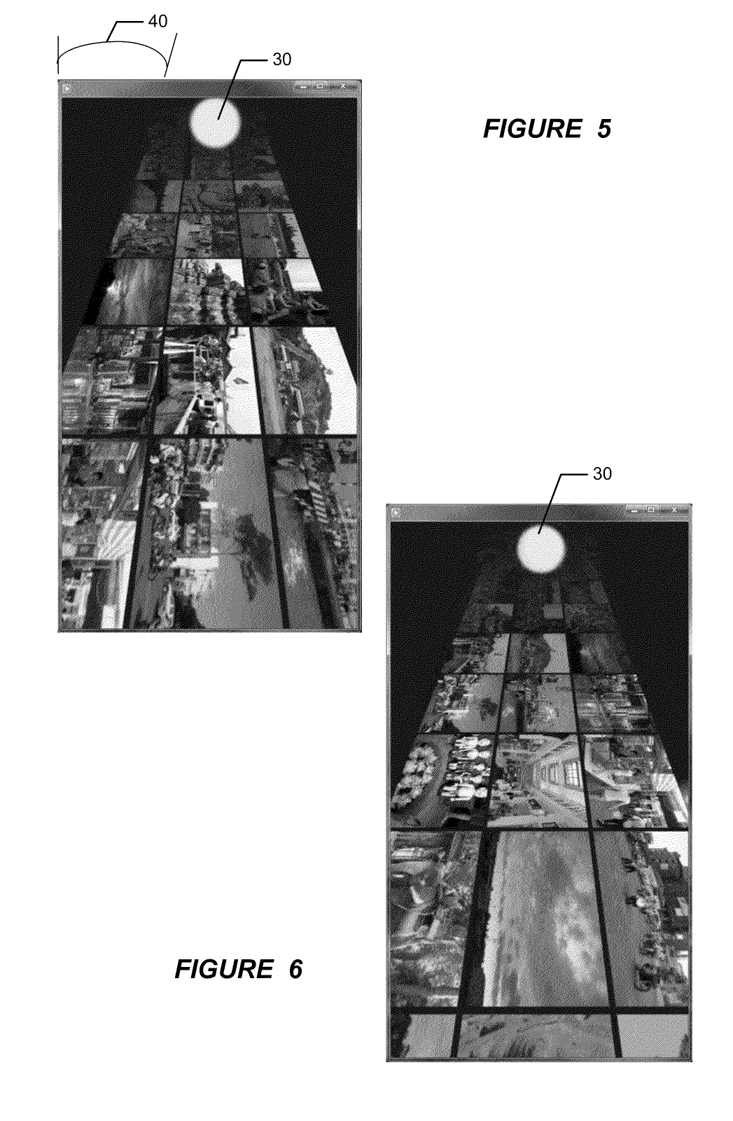

Referring to FIG. 5, the user is now pressing harder on the display screen, illustrated by the smaller diameter circle 30. The electronic device responds to the harder force by further tilting the displayed picture thumbnails at a greater second angle 40 and scrolling the list upward at a greater second speed. FIG. 6 shows another sequential snapshot, following that in FIG. 5, as the user presses more firmly against the screen and causes further tilting of the displayed picture thumbnails and their upward scrolling at a greater third speed.

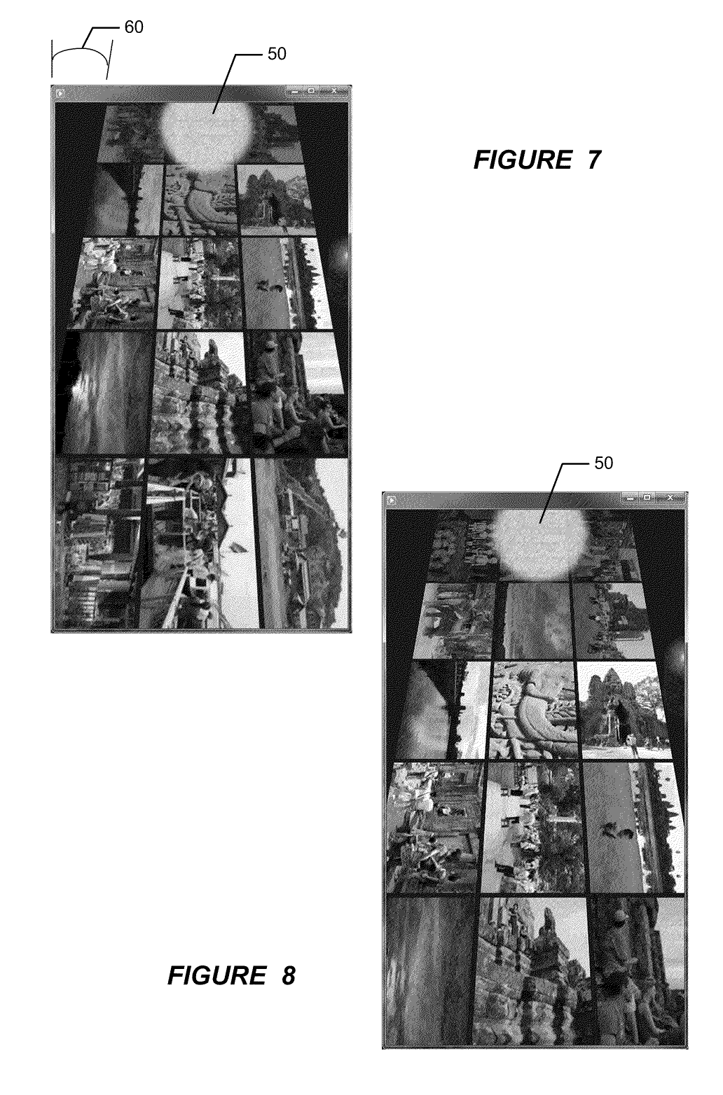

Referring to FIG. 7, the user is now pressing less hard on the display screen, which is illustrated by the larger diameter circle 50. The electronic device responds to the reduced force by reducing the tilting of the displayed picture thumbnails to a smaller angle 60 and scrolling the list at a reduced speed. FIG. 8 shows another sequential snapshot, following that shown in FIG. 7, as the user press still less firmly against the screen and which causes electronic device to tilt the displayed picture thumbnails at a yet smaller angle and scroll down at a further reduced speed.

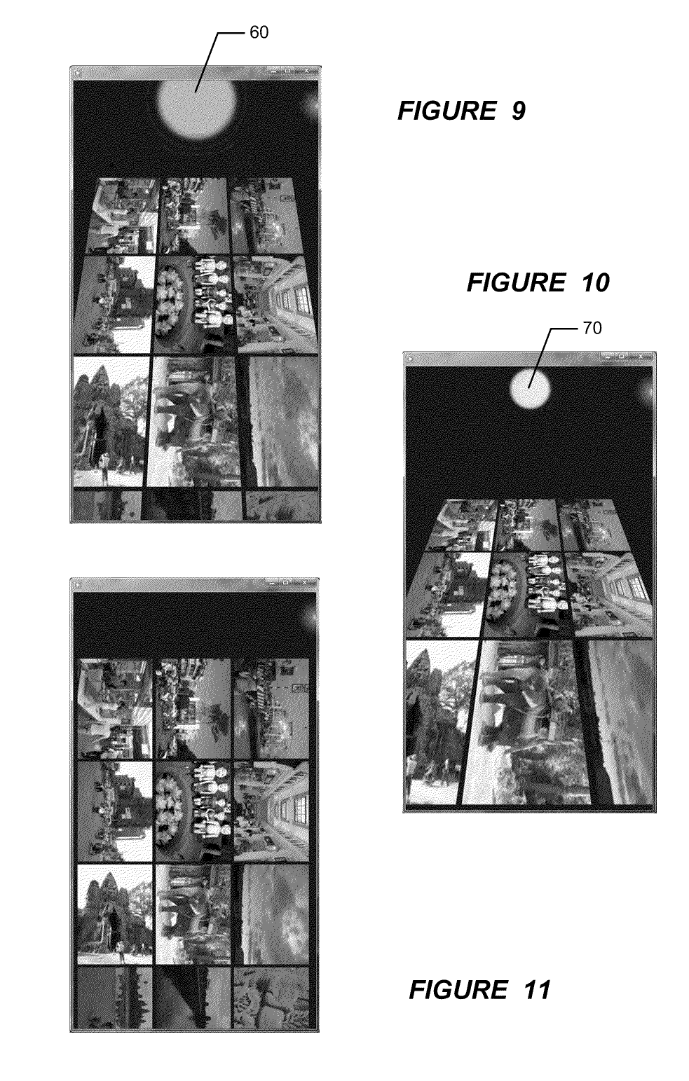

FIGS. 9 and 10 illustrate how the electronic device controls tilting of the displayed picture thumbnails at the end of the list, with less force (i.e., larger diameter circle 60 in FIG. 9) causing less tilting, and a greater force (i.e., smaller diameter circle 70 in FIG. 10) causing greater tilting. FIG. 11 illustrates when the electronic device ceases tilting and scrolling of the displayed picture thumbnails in response to the user ceasing to touch the screen and/or in response to the user touching the screen with less than a defined threshold force.

Although the exemplary embodiments of FIGS. 1-11 have been described in the context of the picture thumbnails being scrolled top to bottom and then bottom to top, the picture thumbnails may alternatively or additionally be scrolled in any direction on the screen (e.g., right-left, diagonally, any other angle or combination thereof).

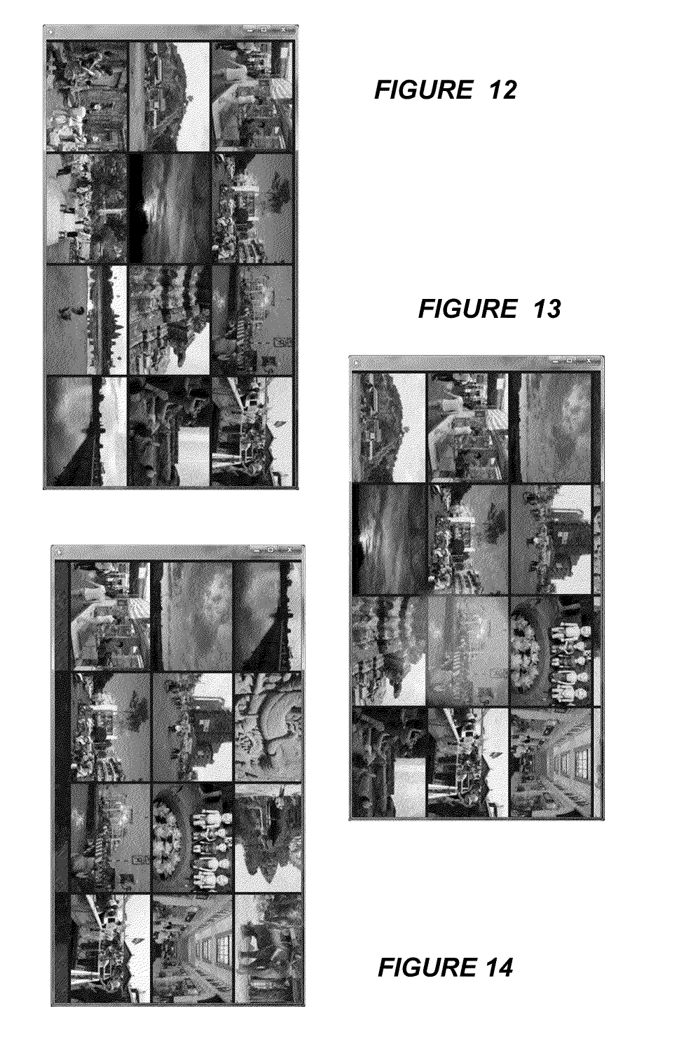

FIGS. 12-24 are exemplary photographs (screenshots) of other operations that may be performed by an electronic device to control tilting of displayed items in a list and to control the rate of scrolling in response to a measure of force exerted by a user on a touch sensitive display screen, in accordance with some other embodiments of the present invention. In FIGS. 12-24, the electronic device controls the tilt angle of the collection displayed picture thumbnails, controls the tilt angle (leaning angle) of each individual picture thumbnails, and controls the speed at which the picture thumbnails are scrolled across the screen responsive to the sensed amount of force exerted by a user on the screen.

Referring to FIGS. 12-14, the user controls the electronic device to sequentially scroll through a list of picture thumbnails by lightly pressing on a defined region of the screen and/or by using a flicking gesture or another gesture. In contrast to FIGS. 1-11 where the picture thumbnails were scrolled up/down relative to the illustrated display screen, in FIGS. 12-24 the picture thumbnails are scrolled right/left relative to the illustrated display screen.

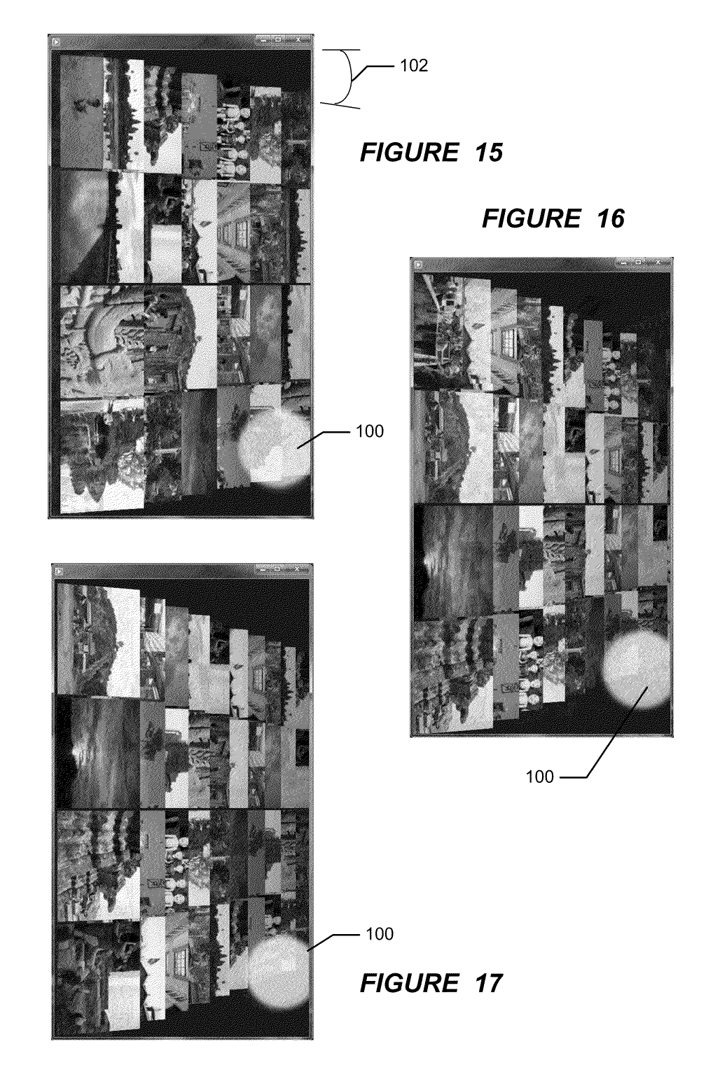

Referring to FIGS. 15-17, in response to the user pressing lightly on the screen (e.g. above a first threshold force), which is illustrated by the relatively large circle 100, the electronic device tilts the collection of displayed picture thumbnails at a first virtual angle 102 relative to the screen. The electronic device also responds to the sensed force by leaning each of the individual picture thumbnails upward at an angle that is controlled relative to the touch force exerted on the screen, to give a visual effect of controlling an angle at which picture cards/tiles are leaning relative to a flat position, in which each picture thumbnail is laying flat on a surface, and another position in which each picture thumbnail is standing upright (e.g. perpendicular to the surface). The electronic device further responds to the sensed force by causing the displayed picture thumbnails to be scrolled at a first speed. The collective tilt angle and individual leaning angle again provides the user with a visual indication of the present speed of the scrolling (e.g., large collective tilt angle and individual leaning angle can correspond to a high scroll speed and small angles can correspond to a low scroll speed, or vice versa). The scrolling continues across the sequential snapshot shown in FIG. 15-17 as the user maintains a relatively constant force and touch position on the display device.

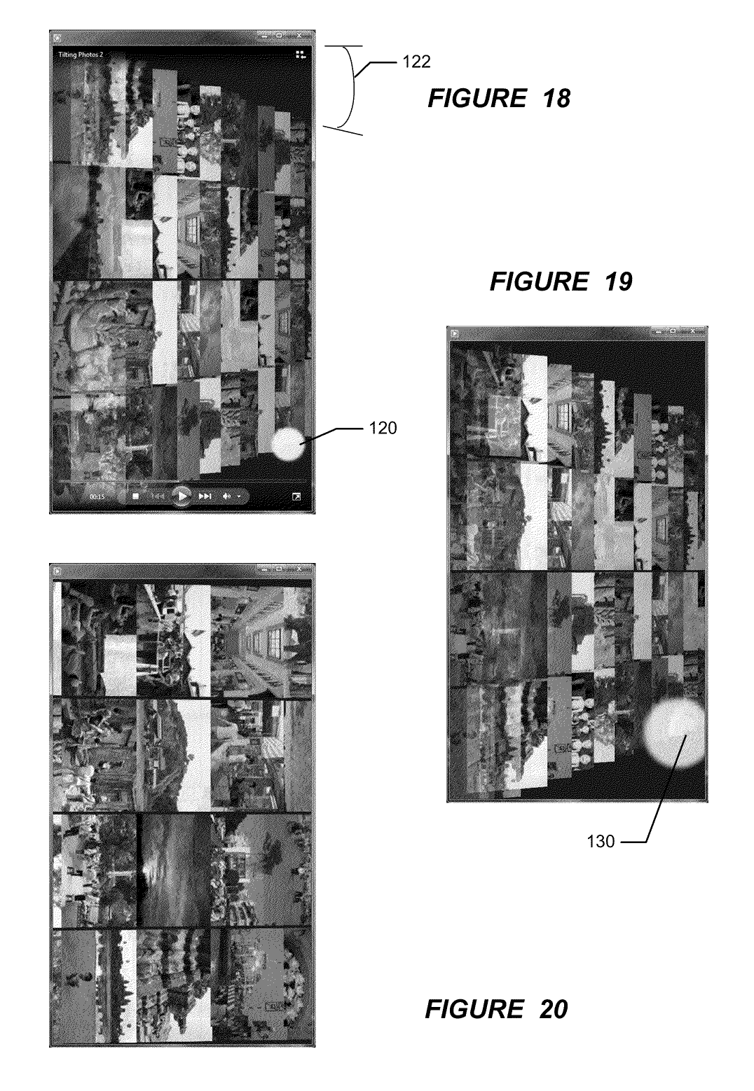

Referring to FIG. 18, in response to the user now pressing harder on the screen (e.g. above a second threshold force), which is illustrated by the smaller circle 120, the electronic device further tilts the displayed collection of picture thumbnails at a greater second angle 122 relative to the display, further leans the individually picture thumbnails upward at a greater angle (i.e., tilts each of the picture thumbnail upward away from the flat position of FIGS. 12-14), and increases the speed at which it scrolls the displayed picture thumbnails across the screen.

Referring to FIG. 19, in response to the user pressing significantly softer on the screen, which is illustrated by the significantly larger diameter circle 130, the electronic device causes the displayed picture thumbnails to be collectively tilted at a smaller angle relative to the display and to be individually tilted downward to a smaller angle (i.e., tilted downward toward the flat position of FIGS. 12-14), and decreases the speed at which it scrolls the displayed picture thumbnails across the screen.

Referring to FIG. 20, response to the user ceasing to touch the screen or touching the screen with less than a defined threshold force, the electronic device responds by ceasing to collectively and individually tilt the displayed picture thumbnails and by maintaining the displayed picture thumbnails static on the screen (i.e., ceasing scrolling). Accordingly, the picture thumbnails are illustrated as if they are lying flat and motionless on a surface.

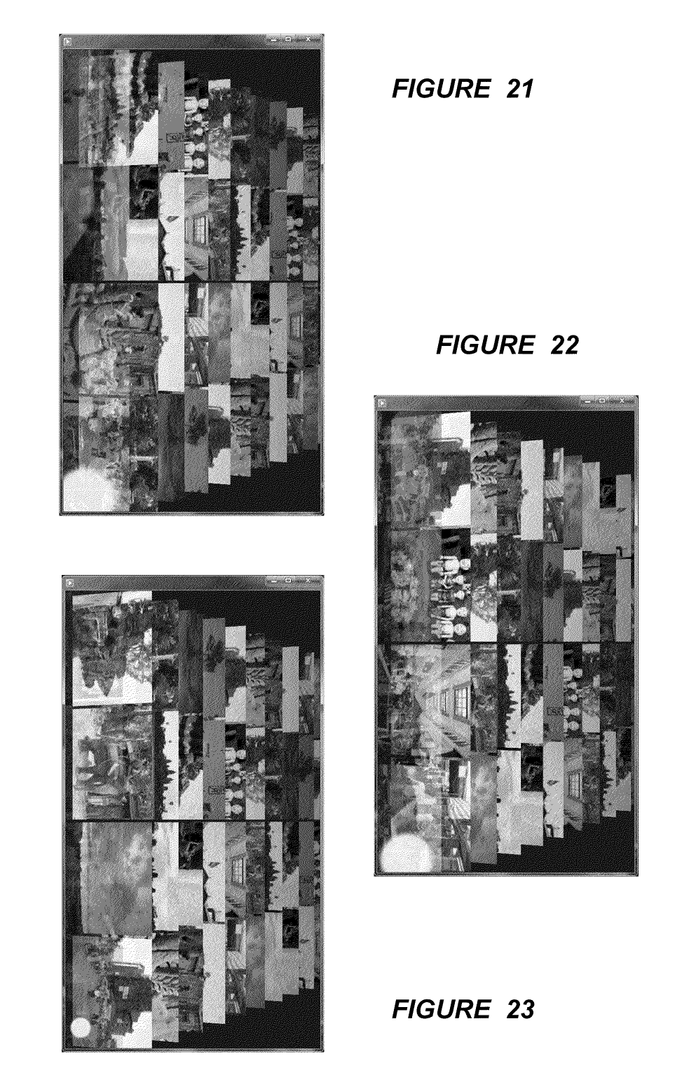

Referring to FIGS. 21-23, the electronic device responds to the user touching another defined location on the screen, such as on the opposite side of the screen from the touch point displayed in FIGS. 15-19, by scrolling the displayed picture thumbnails in an opposite direction to that shown in FIGS. 15-19 (e.g., scrolling right to left instead of left to right as shown in FIGS. 15-19). The user then similarly regulates the collective tilt angle and individual leaning angle of the displayed picture thumbnails and the speed of scrolling through the list of picture thumbnails by controlling the amount of force the user presses against the screen. In FIG. 21, electronic device responds to the user pressing with a first force (illustrated by a first diameter circle in the lower left screen corner) by displaying the picture thumbnails at a first tilt angle and with a first leaning angle, and to scroll the picture thumbnails at a first scroll speed. As the user increases the applied force in FIG. 22 (illustrated by the smaller diameter circle), the electronic device responds by increasing the tilt angle, the leaning angle, and the scroll speed. This user continues to increase applied force in FIG. 23 (illustrated by the much smaller diameter circle), the electronic device responds by further increasing the tilt angle, the leaning angle, and the scroll speed of the displayed picture thumbnails.

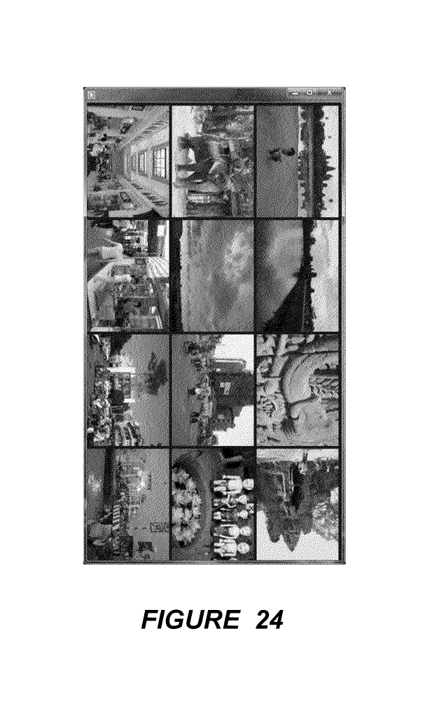

In FIG. 24, the electronic device responds to the user ceasing to touch the screen or to the user touching the screen with less than a defined threshold force by ceasing to tilt and lean the displayed picture thumbnails and ceasing to scroll the displayed picture thumbnails, so that the picture thumbnails appear to rest flat on a surface. Although the exemplary embodiments of FIGS. 12-24 have been described in the context of the picture thumbnails being scrolled right to left and then left to right, the picture thumbnails may alternatively or additionally be scrolled in any direction on the screen (e.g., up-down, diagonally, and any other angle or combination thereof).

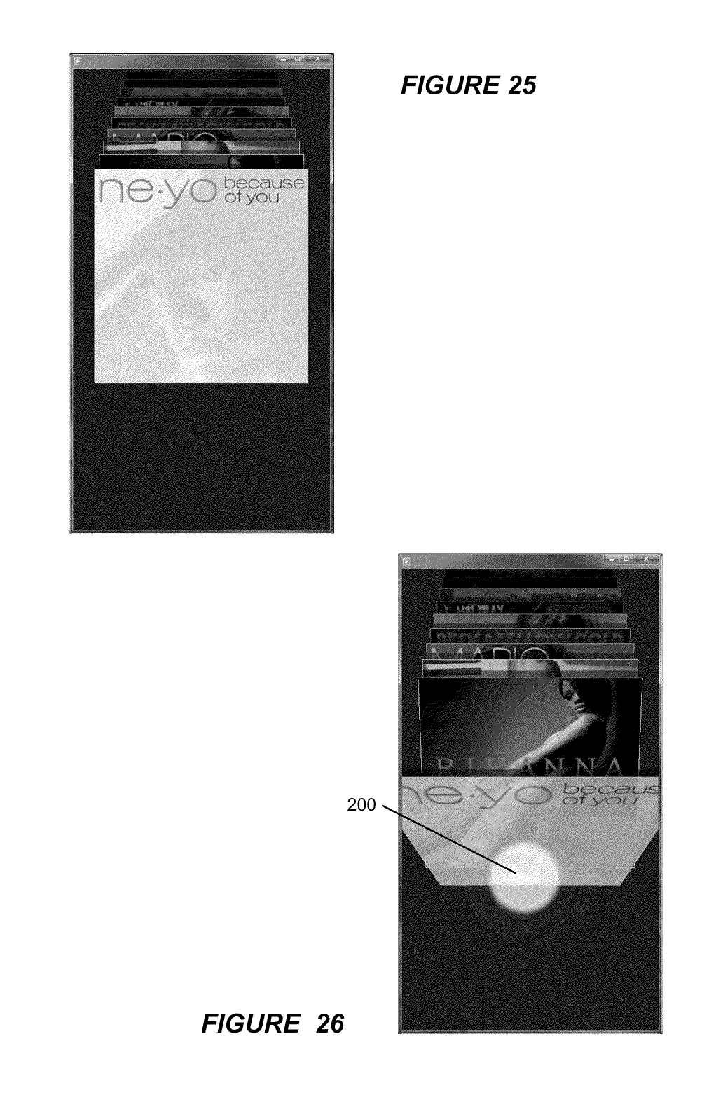

FIGS. 25-34 are exemplary photographs (screenshots) of other operations that may be performed by an electronic device to control tilting of displayed items and to control the rate of scrolling/flipping through the displayed items in response to sensed force exerted by a user on a touch sensitive display screen, in accordance with some other embodiments of the present invention.

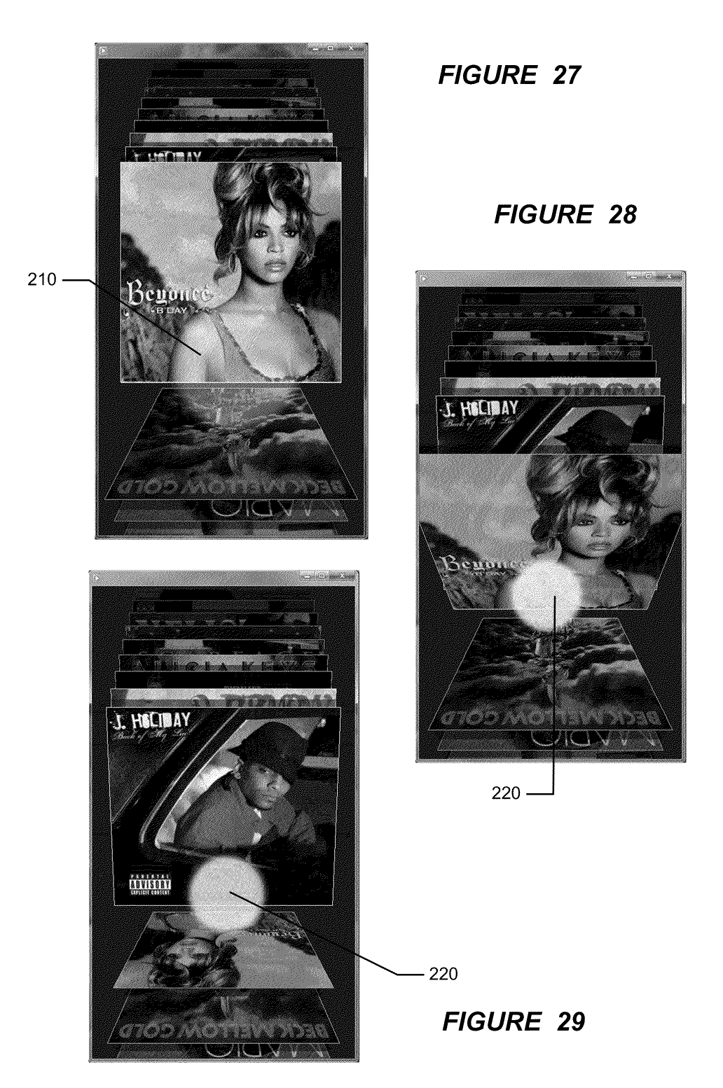

FIG. 25 illustrates an exemplary static view of music/video album covers that are displayed on the screen. In FIG. 26 a user is pressing the screen with a first force (indicated by illustrated by the circle 200 having a first diameter) which causes the electronic device to scroll through the displayed music/video album covers at a first speed. FIGS. 27-29 illustrate a sequence of images that may occur as the user presses the screen initially softly, illustrated by the larger diameter circle 210 in FIG. 27, and then subsequently harder, illustrated by the smaller diameter circle 220 in FIGS. 28 and 29. The user may control the direction of scrolling by touching the screen at different defined locations. For example, the electronic device may scroll through the displayed music/video album covers in one direction (e.g., top to bottom) responsive to the user pressing on a lower half of the screen, and may scroll through the displayed music/video album covers in the opposite direction (e.g., bottom to top) responsive to the user pressing on an upper half of the screen.

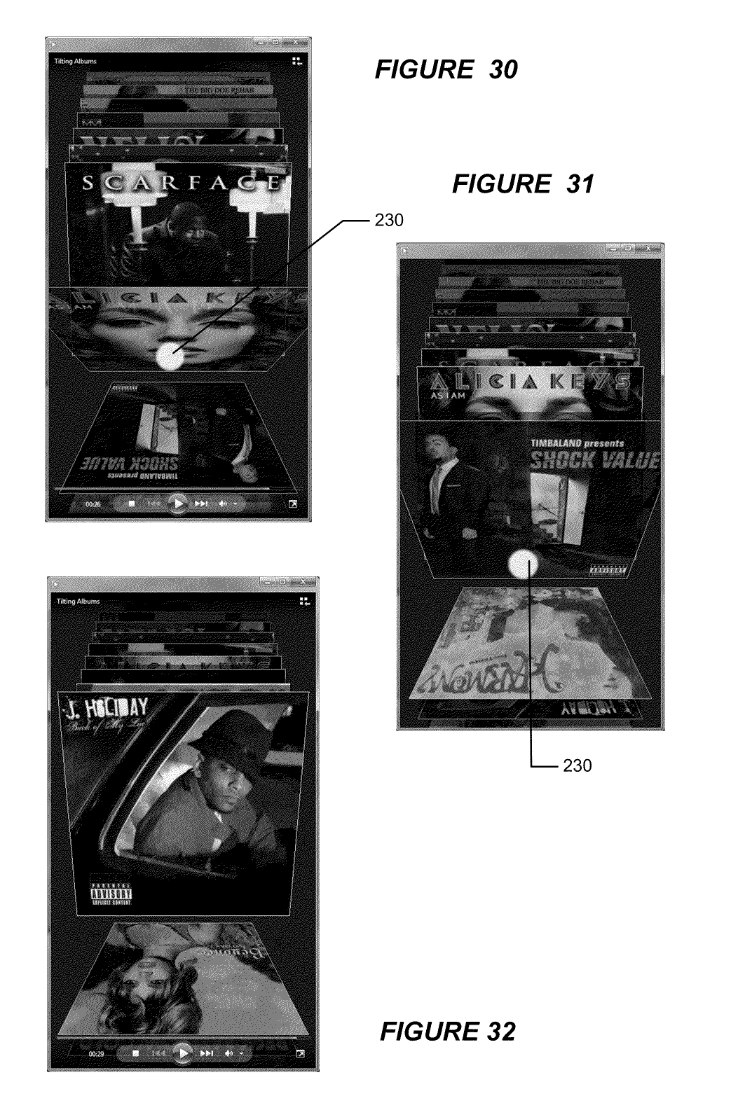

In FIGS. 30 and 31, the user presses harder on the screen (e.g., illustrated by the smaller touch circle 230) to cause the electronic device to scroll faster through the displayed music/video album covers. The electronic device may not display all music/video album covers that occur in sequence as the list is scrolled at higher rates. For example, the electronic device may skip a display of some music/video album covers that occur in the scrolled sequence to, for example, improve the viewability of what is being displayed to the user (e.g., decrease perceived blurring of the displayed images from an excessive rate of change of the displayed images).

In FIG. 32, the electronic device ceases scrolling through the displayed music/video album covers in response to the user ceasing to touch the screen or touching the screen with less than a defined threshold force.

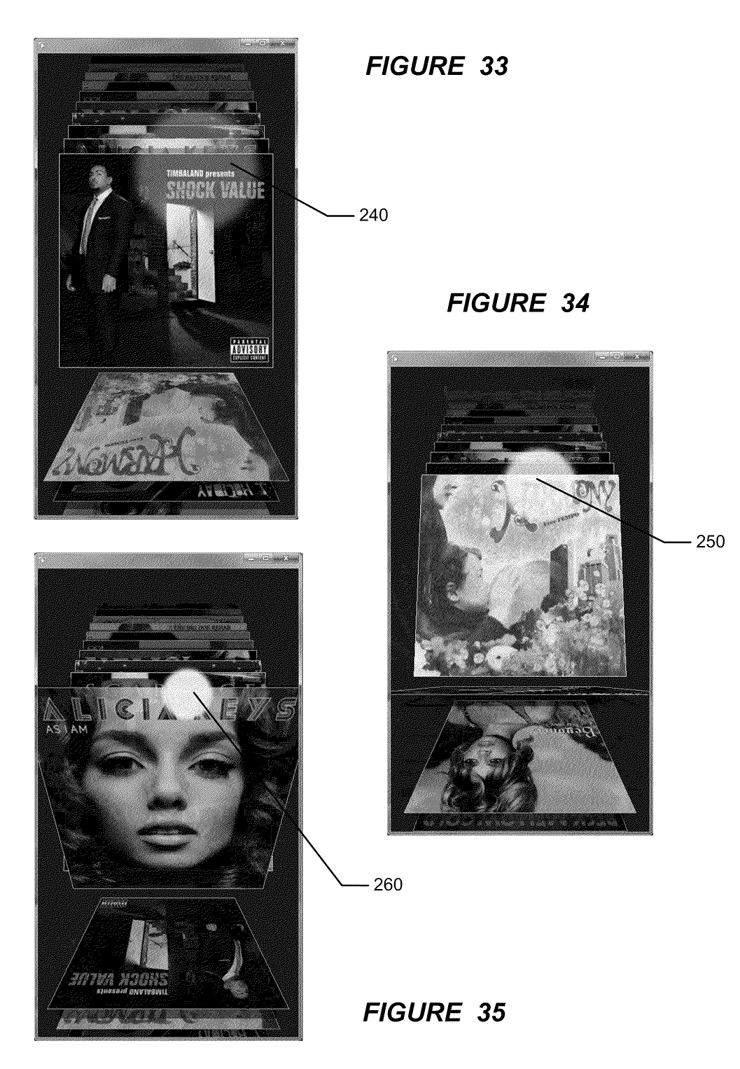

FIGS. 33-35 illustrates that the electronic device can be configured to scroll through the displayed music/video album covers in an opposite direction to that shown in Figures such as 25-31 in response to the user touching an upper portion of the display screen. As before, the user can control the rate of scrolling by regulating how hard the user presses the screen. In FIG. 33, the user is lightly pressing the screen (e.g., larger illustrated circle 240), and in FIGS. 34 and 35 the user is pressing increasingly harder on the screen (e.g., smaller illustrated circles 250 and 260) to further increase the scroll speed through the collection of music/video album covers.

Accordingly, in some embodiments, pictures in the arrangement are sequentially flipped downward from an upright orientation to a flat orientation (e.g., appearing to rest on a virtual surface) to sequential reveal a next picture in the arrangement, and the flipping speed is regulated responsive to the force signal. Flipping through the arrangement of pictures can cease responsive to the force signal indicating the user is not exerting force against the force sensor (e.g., is exerting less than a threshold force against the force sensor). Direction of the flipping can be reversed in response to the user changing from pressing a first region of the screen to instead pressing a spaced apart second region of the screen.

FIG. 36 is a block diagram of an exemplary electronic device that may be configured to operate in accordance with at least some of the embodiments that are described herein. Although the electronic device has been illustrated as being a wireless communication terminal, the invention is not limited thereto and may be embodied in any type of device that includes a display screen, that is configured to sense an amount of force that a user is pressing against the device, and that is configured to control how information is scrolled across the display responsive to the sensed force. Although various embodiments have been described in the context of the electronic device sensing force that is exerted on the display screen, the device may alternatively or additionally be configured to sense and respond to how much force is applied to a button, joystick, keypad key, or other user interfaces of the device.

The electronic device can be configured to control scrolling through any type of displayed information responsive to the sensed force and, therefore, is not limited to controlling scrolling of thumbnail pictures of photos, movies, and/or and music album (e.g., CD) covers. Accordingly, the electronic device can be configured to control scrolling through, for example, any indicia representing contents of a file folder, email in an email folder, individual contact information within a contact list, action item lists, song lists, picture lists, movie lists, and any other information within the device that can be organized into lists and visually displayed in an ordered manner on a display device. Moreover, the electronic device may be configured to increase tilting/leaning and/or scrolling speed responsive to increased force being applied by a user, or the electronic device may be configured to oppositely decrease tilting/leaning and/or scrolling speed responsive to increased force. Moreover, the tilt/lean angle and scrolling speed may be controlled oppositely to what is described above (i.e., decreased angle may represent a slower scrolling speed and increased angle may represent a faster scrolling speed).

Referring to FIG. 36, the exemplary electronic device 300 includes a controller circuit 310 and a display screen 330. The controller circuit 310 may include a general purpose processor circuit and/or a digital signal processor circuit that can execute instructions from a computer readable memory, which may reside therein or may be connected thereto, and/or a logic gate array configured to perform at least some of the operations and methods described herein. The display screen 330 may be a touch sensitive display screen that generates a location signal that indicate a location on the screen that is being touched by the user, and may include a force sensor 332 that is configured to generate a force signal that indicates how much force the user is exerting on the display screen 330 at that location. The force sensor 332 may be separate from the display screen 330. For example, the force sensor 332 may be part of the user input interface 340 and configured to generate a force signal that indicates how much force a user is exerting against a button, keypad key, or another part of the electronic device 300. The electronic device 300 may further include a speaker 350, a microphone 360, and a transceiver circuit 320.

A memory circuit 370 can store a music file catalog 372 of digital music files, a picture file catalog 374 or digital pictures, a video file catalog 376 of digital videos, and/or other lists of information (e.g., email in an email folder, individual contact information within a contact list, action item lists) within the device that can be visually displayed on the display screen 330. The controller circuit 310 is configured to display on the display screen 330 a defined number of the items in one or more of the catalogs 372-376, and is configured to operate in accordance with one or more of the embodiments described herein, to control a speed at which it scrolls though the items that are displayed from the catalogs 372-376 and to control a tilt angle of the displayed items (to visually illustrate the scroll speed to a user) in response to how much force the force signal is indicating that the user is pressing against the display screen 330.

The transceiver circuit 320 may be configured to encode/decode and transmit and receive RF communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS), WiMAX, and/or Long Term Evolution (LTE), and/or according to a WLAN (e.g., 802.11) and/or Bluetooth protocol.

Many alterations and modifications may be made by those having ordinary skill in the art in view of the present disclosure and without departing from the spirit and scope of the invention. Various embodiments of the present invention are, therefore, to be read to include not only the combination of elements which are literally set forth but all equivalent elements for performing substantially the same function in substantially the same way to obtain substantially the same result.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. An electronic device comprising:
a display screen;
a force sensor that is configured to generate a force signal that indicates an amount of force being exerted thereon by a user; and
a controller circuit that is configured to control a speed at which information items are scrolled on the display screen responsive to the force signal.

2. The electronic device of claim 1, wherein:
the controller circuit is further configured to control a speed at which information items are scrolled across the display screen and to control a tilt angle of the displayed information items responsive to the force signal.

3. The electronic device of claim 2, wherein:
the controller circuit is further configured to display the information items with no tilt angle when the force signal indicates that no force from the user is sensed by the force sensor.

4. The electronic device of claim 2, wherein:
the controller circuit is further configured to graphically render the tilt angle of the displayed information items including by tapering width of the displayed information items in a defined direction and by regulating the tapered width of the displayed information items responsive to the force signal.

5. The electronic device of claim 2, wherein:
the display screen comprises a touch sensitive display screen that is configured to identify a location thereon where a user is pressing, and the force sensor is configured so that the force signal indicates how hard the user is pressing against the touch sensitive display screen; and
the controller circuit is further configured to control the scrolling speed and tilt angle of the information items that are displayed on the touch sensitive display screen responsive to the force signal.

6. The electronic device of claim 5, wherein:
the controller circuit is further configured to increase the scrolling speed and increase the tilt angle of the displayed information items, to provide a visual indication to the user of the increased scrolling speed, responsive to the force signal indicating that the user is pressing harder against the touch sensitive display screen.

7. The electronic device of claim 6, wherein:
the controller circuit is further configured to decrease the scrolling speed and decrease the tilt angle of the displayed information items, to provide a visual indication to the user of the decreased scrolling speed, responsive to the force signal indicating that the user is pressing less hard against the touch sensitive display screen.

8. The electronic device of claim 7, wherein:
the controller circuit is further configured to scroll the displayed information items in a first direction in response to the user touching within a first region of the touch sensitive display screen and while regulating the scrolling speed in the first direction responsive to the force signal, and is configured to scroll the displayed information items in an opposite second direction in response to the user touching the touch sensitive display screen within a second region, which is spaced apart from the first region, and while regulating the scrolling speed in the second direction responsive to the force signal.

9. The electronic device of claim 5, wherein:
the controller circuit is further configured to increase the scrolling speed and decrease the tilt angle of the displayed information items, to provide a visual indication to the user of the increased scrolling speed, responsive to the force signal indicating that the user is pressing harder against the touch sensitive display screen, and is configured to decrease the scrolling speed and increase the tilt angle of the displayed information items, to provide a visual indication to the user of the decreased scrolling speed, responsive to the force signal indicating that the user is pressing less hard against the touch sensitive display screen.

10. The electronic device of claim 5, wherein:
the controller circuit is further configured to display a defined object at the location where the user is pressing against the touch sensitive display screen, is configured to decrease the size of the displayed object responsive to the force signal indicating that the user is pressing harder against the touch sensitive display screen, and is configured to increase the size of the displayed object responsive to the force signal indicating that the user is pressing less hard against the touch sensitive display screen.

11. The electronic device of claim 5, wherein:
the controller circuit is further configured to display a defined object at the location where the user is pressing against the touch sensitive display screen, is configured to increase the size of the displayed object responsive to the force signal indicating that the user is pressing harder against the touch sensitive display screen, and is configured to decrease the size of the displayed object responsive to the force signal indicating that the user is pressing less hard against the touch sensitive display screen.

12. The electronic device of claim 2, wherein:
the controller circuit is further configured to scroll an arrangement of pictures across the display screen and to control the scroll speed and the tilt angle of the displayed arrangement of pictures responsive to the force signal.

13. The electronic device of claim 12, wherein:
the controller circuit is further configured to graphically render the tilt angle of the displayed arrangement of pictures including by tapering width of the displayed arrangement of pictures in a defined direction and by regulating the tapered arrangement width of the displayed arrangement of pictures responsive to the force signal.

14. The electronic device of claim 13, wherein:
the controller circuit is further configured to control a leaning angle of individual ones of the displayed pictures responsive to the force signal including by graphically rendering the individual pictures with a tapered picture width of the individual pictures in the defined direction and by regulating the tapered individual picture width responsive to the force signal.

15. The electronic device of claim 14, wherein:
the controller circuit is further configured to increase both the tilt angle of the arrangement of pictures and the leaning angle of each of the pictures within the arrangement in response to the force signal indicating that the user is exerting a greater force on the force sensor, and is configured to decrease both the tilt angle of the arrange of pictures and the leaning angle of each of the pictures within the arrangement in response to the force signal indicating that the user is exerting less force on the force sensor.

16. The electronic device of claim 1, wherein:
the controller circuit is further configured to scroll through a stacked arrangement of pictures on the display screen by sequentially flipping through the pictures to sequentially reveal a next picture in the arrangement while adding further pictures to a back end of the arrangement, and to control speed at which the pictures are sequentially flipped through responsive to the force signal.

17. The electronic device of claim 16, wherein:
the controller circuit is further configured to flip through the pictures in the arrangement in a first direction in response to the user touching the display screen within a first region and while regulating the flipping speed in the first direction responsive to the force signal, and is configured to flip through the pictures in the arrangement in an opposite second direction in response to the user touching the touch sensitive display screen within a second region, which is spaced apart from the first region, and while regulating the flipping speed in the second direction responsive to the force signal.

18. The electronic device of claim 16, wherein:
the controller circuit is further configured to sequentially flip pictures downward from an upright orientation to a flat orientation to sequential reveal a next picture in the arrangement, to control the flipping speed responsive to the force signal, and to cease flipping through the pictures responsive to the force signal indicating that the user is not exerting force against the force sensor.

19. The electronic device of claim 16, wherein:
the controller circuit is further configured to render the pictures in the arrangement to be illustrative of a stack of music/video album covers, and is configured to sequentially flip through the stack of music/video album covers to sequential reveal a next music/video album cover in the stack, and to control the flipping speed responsive to the force signal.

20. An electronic device comprising:
a touch sensitive display screen that is configured to identify a location where a user is pressing and to generate a force signal that indicates how hard the user is pressing; and
a controller circuit that is configured to control a speed at which information items are scrolled across the screen and to control a tilt angle of the displayed information items responsive to the force signal, wherein the controller circuit graphically renders the tilt angle on the screen by tapering width of the displayed information items in a defined direction and regulates the tapered width responsive to the force signal, wherein the controller circuit renders no tilt angle when the force signal indicates that the user is not pressing the screen, and the controller circuit increases the scrolling speed and the tilt angle of the displayed information items, to provide a visual indication to the user of the increased scrolling speed, responsive to the force signal indicating that the user is pressing harder against the screen.
